(19) United States
(12) Patent Application Publication
(10) Pub. No.: US 2005/0020738 A1
(43) Pub. Date: Jan. 27, 2005

(54) Crosslinkable adhesive silicone composition comprising as gelling agent a compound with cyclic amine function borne by a siloxane chain

(76) Inventors: Scott Jackson, Rock Hill, SC (US); Alain Pouchelon, Meyzieu (FR)

Correspondence Address: Jean Louis Seugnet;Rhodia Inc, 259 Prospect Plains Road, CN 7500, Cranbury, NJ, 08512-7500, US

(21) Appl. No.: 10/493,939

(22) PCT Filed: Oct. 30, 2002
(86) PCT No.: PCT/FR02/03733

(30) Foreign Application Priority Data
Oct. 31, 2001 (FR) 01/14151

(51) Int. Cl. C08K 5/34

(52) U.S. Cl. 524/99

(57) ABSTRACT

The invention relates to a crosslinkable adhesive silicone composition of the type of those comprising a polyorganosiloxane (POS) comprising Si-Vi units (α,ω-di-Vi-polydimethylsiloxane); a crosslinking POS comprising SiH units; a platinum catalyst; a filler; and optionally an adhesion promoter comprising vinyltrimethoxysilane, 3-glycidoxypropyltrimethoxy-silane and butyl titanate and/or a crosslinking inhibitor and/or an unsaturated POS resin of the MM^{Vi}DD^{Vi}Q or MD^{Vi}Q or MM^{Vi}Q type. This composition is characterized in that it additionally comprises a polyorganosiloxane having, per mole, at least one piperidinyl functional group.

The field of the present invention is that of silicone elastomer compositions which can be crosslinked by addition and/or condensation. The polyorganosiloxanes (POS) considered are of the room temperature vulcanizable (RTV) type, it being known that, conventionally, they are provided in the form of two-component systems (RTV-2), the vulcanization of which, in the case of crosslinking by addition, can be, according to the use, accelerated with heat.

These products are particularly known for their applications in the field of moulding and of reproduction; they can then be formed by casting, injection moulding, deposition with a brush, spraying, and the like, according to the use.

In the context of the present invention, interest is more particularly displayed in self-adhesive silicone elastomer compositions which crosslink by an addition reaction and which exhibit modified Theological properties.

More specifically still, the present invention is targeted at crosslinkable adhesive silicone elastomer compositions comprising a thixotropic agent of type: POS comprising a piperidinyl functional group, which confers a high yield point on these compositions. The term “yield point” is understood to mean the ability of a product not to flow spontaneously under its own weight.

Adhesive silicone elastomer compositions of the RTV type are now well known and have formed the subject of various applications. Thus, the use of such compositions for the adhesive bonding of various substrates, of electrical/electronic components or of mechanical components, in particular in the motor vehicle field or domestic electrical appliance field, is known. Such a composition, exhibiting good stability on storage, a viscosity in the liquid form appropriate for the requirements of ease of application on the substrates to be adhesively bonded, a high adhesiveness, good behaviour with regard to temperature and good stability of the adhesiveness over time, while having a low cost price, is disclosed in Patent FR-A-2 775 481.

While this composition proves to be an adhesive silicone composition of choice for the abovementioned applications, it does not exhibit Theological characteristics entirely suited to certain specific applications (non-drip device, seal shaped in place, and the like) where the method of deposition requires a yield point of the product.

By analogy with moulding applications, it would then be necessary to add thixotropic additives to the composition in order to make it possible to thicken, to the correct extent, silicone elastomer compositions without, however, affecting their malleability, their fluidity necessary for the handling thereof, and so that the composition, before crosslinking, does not flow spontaneously if this is not required.

Mention may be made, as thixotropic agent, of:
an ultrafine silica in an appropriate proportion;
hydroxylated and aminated additives.

However, depending on the situation, these additives have totally unacceptable disadvantages.

The disadvantage of the silicas is that they result in a great increase in both the yield point and the viscosity.

The problem of the hydroxylated and aminated additives is that they do not bring about the increase in the yield point desired for all the types of compositions of the field. Furthermore, the aminated derivatives inhibit the action of the platinum catalysts used in the silicone compositions which can be crosslinked by addition.

Thus, an object of the present invention is to develop a silicone composition which can be crosslinked to an elastomer which exhibits rheological properties perfectly suited to allowing the composition to be used with success both for the adhesive bonding of various substrates and for carrying out moulding operations requiring non-flowing materials.

Another object is to obtain a non-flowing composition which can be crosslinked by polyaddition and, in addition, which can be self-adhesive in the case of adhesive bonding applications.

In addition, in the context of the use thereof in adhesive bonding, the composition according to the invention must make it possible to obtain a firm combination which withstands weak stresses, this being the case from the time of its instalment (adhesive bonding between the substrates). It must also make it possible to obtain good stability of the adhesiveness over time.

Furthermore, in the context of the moulding and adhesive bonding applications, another object is to obtain a composition which can be easily formed and which is capable of retaining the form thus fashioned at least for the time necessary for the crosslinking. Finally, this composition must retain good mechanical properties and a satisfactory thermal behaviour.

To achieve these objects, the inventors have had the credit of demonstrating, in an entirely surprising and unexpected way, that the use in a crosslinkable silicone composition of a compound comprising at least one cyclic amine functional group carried by a siloxane chain greatly increases the yield point of the composition.

The inventors are all the more worthy of credit since they have countered the preconception according to which aminated compounds are conventionally inhibitors of platinum-based compounds advantageously used to catalyse the crosslinking of silicone compositions by addition.

Thus it is that the present invention satisfies the abovesaid objects, among others, by providing, first, a crosslinkable adhesive silicone composition of the type of those comprising:
(I) at least one polyorganosiloxane exhibiting, per molecule, at least two alkenyl groups bonded to the silicon,
(II) at least one polyorganosiloxane exhibiting, per molecule, at least three hydrogen atoms bonded to the silicon,
(III) a catalytically effective amount of at least one catalyst composed of at least one metal belonging to the platinum group,
(IV) optionally an adhesion promoter,
(V) an inorganic filler,
(VI) optionally at least one crosslinking inhibitor,
(VII) optionally at least one polyorganosiloxane resin carrying Q and/or T siloxyl units and alkenyl groups,
this composition also comprising:
(VIII) at least one compound comprising at least one cyclic amine functional group carried on at least one siloxane chain, as thixotropic additive which modifies the Theological properties of the composition by conferring thereon a high yield point.

Preferably, the cyclic amine functional group is a piperidinyl functional group.

Advantageously, the compound (VIII) is a polyorganosiloxane having, per molecule, at least one unit of general formula:

$${( R )}_{a} {( X )}_{b} {Z Si ( O )}_{\frac{3 - ( a + b )}{2}} \qquad ( I )$$

in which:
the R symbols are identical or different and represent a monovalent hydrocarbonaceous radical chosen from alkyl radicals having from 1 to 4 carbon atoms, the phenyl radical and the 3,3,3-trifluoropropyl radical;
the X symbols are identical or different and represent a monovalent radical chosen from a hydroxyl group, a linear-or branched alkenyl radical and a linear or branched alkoxy radical having from 1 to 3 carbon atoms;
Z represents a residue comprising sterically hindered piperidinyl group(s) which is chosen from:
   ♦ the residues of formula: 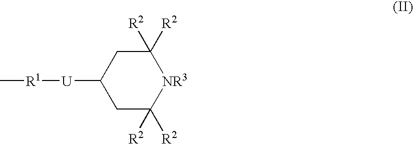
      in which:
R¹ is a divalent hydrocarbonaceous radical chosen from:
linear or branched alkylene radicals having from 2 to 18 carbon atoms;
alkylenecarbonyl radicals, the linear or branched alkylene part of which comprises 2 to 20 carbon atoms;
alkylenecyclohexylene radicals, the linear or branched alkylene part of which comprises from 2 to 12 carbon atoms and the cyclohexylene part of which comprises an —OH group and optionally 1 or 2 alkyl radicals having from 1 to 4 carbon atoms;
radicals of formula —R⁴—O—R⁵— in which the R⁴ and R⁵ radicals, which are identical or different, represent alkylene radicals having 1 to 12 carbon atoms;
radicals of formula —R⁴—O—R⁵— in which the R⁴ and R⁵ radicals have the meanings indicated above and one or both of them are substituted by one or two OH group(s);
radicals of formulae —R⁴—COO—R⁵— and —R⁴—OCO—R⁵— in which R⁴ and R⁵ have the above meanings; radicals of formula —R⁶—O—R⁷—O—CO—R⁸— in which R⁶, R⁷ and R⁸, which are identical or different, represent alkylene radicals having from 2 to 12 carbon atoms and the R⁷ radical is optionally substituted by a hydroxyl group;
U represents —O— or —NR⁹—, R⁹ being a radical chosen from: a hydrogen atom; a linear or branched alkyl radical having from 1 to 6 carbon atoms; a divalent radical —R¹— which has the meaning indicated above, one of the valency bonds being connected to the nitrogen atom of —NR⁹— and the other being connected to a silicon atom; and a divalent radical of formula: 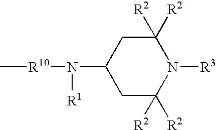
in which R¹ has the meaning indicated above, R² and R³ have the meanings indicated below and R¹⁰ represents a linear or branched alkylene radical having 1 to 12 carbon atoms, one of the valency bonds (that of R¹⁰) being connected to the nitrogen atom of —NR⁹— and the other (that of R¹) being connected to a silicon atom;
R² are identical or different radicals chosen from linear or branched alkyl radicals having from 1 to 3 carbon atoms and the phenyl radical;
R³ represents a hydrogen atom or the R² radical;
♦ and those of formula: 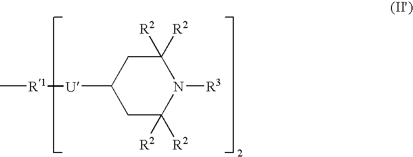
   in which:
R′¹ is chosen from a trivalent radical of formula: 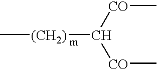
where m represents a number from 2 to 20,
and a trivalent radical of formula: 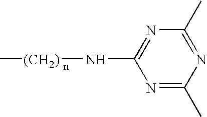
where n represents a number from 2 to 20;
U′ represents —O— or —NR¹¹—, R¹¹ being a hydrogen atom or a linear or branched alkyl radical having from 1 to 6 carbon atoms;
R² and R³ have the same meanings as those given with respect to the formula (II);
a is a number chosen from 0, 1 and 2;
b is a number chosen from 0, 1 and 2;
the sum a+b is at most equal to 2.

This polyorganosiloxane (VIII) can additionally comprise at least one other siloxyl unit of formula:

$${( R )}_{c} {( X )}_{d} {V Si ( O )}_{\frac{3 - ( c + d )}{2}} \qquad ( III )$$

in which:
   the R and X symbols have the same meanings as those given above with respect to the formula (I);
   the V symbol represents: a linear or branched alkyl radical having from 5 to 20 carbon atoms; a radical of formula —(CH₂)ₚ—COO—R¹² in which p represents a number from 5 to 20 and R¹² represents a linear or branched alkyl radical having from 1 to 12 carbon atoms; a radical of
   formula —(CH₂)_{q}—O—R¹³ in which q represents a number from 3 to 10 and R¹³ represents a hydrogen atom, an ethylene oxide sequence, a propylene oxide sequence, a mixed ethylene oxide+propylene oxide sequence or an acyl radical having from 2 to 12 carbon atoms;
c is a number chosen from 0, 1 and 2;
d is a number chosen from 0, 1 and 2;
the sum c+d is at most equal to 2.

It can also advantageously comprise other siloxyl unit(s) of formula:

$${( R )}_{e} {( X )}_{f} {Si ( O )}_{\frac{4 - ( e + f )}{2}} \qquad ( IV )$$

in which:
R and X have the same meanings as those given with respect to the formula (I);
e is a number chosen from 0, 1, 2 and 3;
f is a number chosen from 0, 1, 2 and 3;
the sum e+f is at most equal to 3.

Thus, preferably, the polyorganosiloxane (VIII) is a linear polydiorganosiloxane of mean formula: 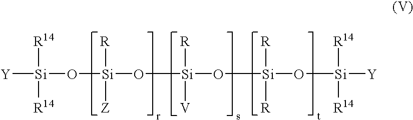
in which:
the R, Z and V symbols have the meanings given above with respect to the formulae (I) and (III);
the Y symbol represents a monovalent radical chosen from the R, Z, V and X radicals;
the R¹⁴ symbols are identical or different and represent a monovalent radical chosen from an R radical and an X radical as defined above with respect to the formula (I);
r, s and t are equal to zero or represent integers or fractional numbers of greater than zero, with the additional condition according to which, if r=0, at least one of the two Y radicals represents the Z radical.

According to a preferred embodiment, the compound comprising a piperidinyl functional group corresponds to the following formula: 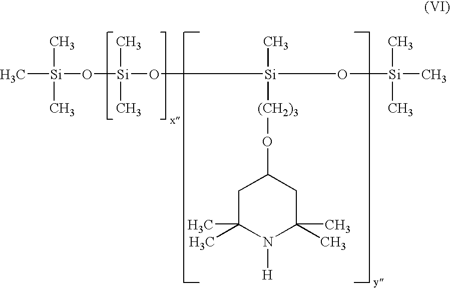
in which
   x″ is between 0 and 1000,
   y″ is between 1 and 50,
      the proportion of compound (VI) in the composition preferably being between 0.2 and 5%.

The present compound, in the form of an oil, advantageously makes it possible to obtain a composition for which the Bingham threshold can reach 350 Pa.

The polyorganosiloxane (I) is, by weight, one of the essential constituents of the composition used according to the invention. Advantageously, it is a product exhibiting units of formula:

$${W}_{a} {Z}_{b}^{′} {SiO}_{\frac{4 - ( a + b )}{2}} \qquad ( VII )$$

in which:
   W is an alkenyl group, preferably a vinyl or allyl group,
   Z′ is a monovalent hydrocarbonaceous group which has no unfavourable effect on the activity of the catalyst and is preferably chosen from alkyl groups having from 1 to 8 carbon atoms inclusive, advantageously from the methyl, ethyl, propyl and 3,3,3-trifluoropropyl groups, and as well from aryl groups, advantageously from the xylyl, tolyl and phenyl radicals,
a is 1 or 2, b is 0, 1 or 2, and a+b is between 1 and 3, preferably between 2 and 3,
optionally at least a portion of the other units being units of mean formula:

$${Z}_{c}^{′} {SiO}_{\frac{4 - c}{2}} \qquad ( VIII )$$

in which Z′ has the same meaning as above and c has a value of between 0 and 3, preferably between 2 and 3.

It is advantageous for this polydiorgano-siloxane to have a viscosity at least equal to 100 mPa·s, preferably to 500 mPa·s, and more preferably still of between 500 and 100 000 mPa·s. Mention may be made, by way of example of compound (I), of poly-dimethylsiloxane.

The polydimethylsiloxane (I) can be formed solely of units of formula (VII) or can additionally comprise units of formula (VIII). Likewise, it can exhibit a linear, branched, cyclic or network structure. Its degree of polymerization is preferably between 2 and 5000.

Z′ is generally chosen from the methyl, ethyl and phenyl radicals, at least 60 mol % of the Z′ radicals being methyl radicals.

Examples of siloxyl units of formula (VII) are the vinyldimethylsiloxane unit, the vinylphenyl-methylsiloxane unit and the vinylsiloxane unit.

Examples of siloxyl units of formula (VIII) are the SiO_{4/2}, dimethylsiloxane, methylphenylsiloxane, diphenylsiloxane, methylsiloxane and phenylsiloxane units.

Examples of polyorganosiloxanes (I) are dimethylpolysiloxanes comprising dimethylvinylsilyl ends, methylvinyldimethylpolysiloxane copolymers comprising trimethylsilyl ends, methylvinyldimethylpolysiloxane copolymers comprising dimethylvinylsilyl ends, or cyclic methylvinylpolysiloxanes.

The polyorganosiloxane (II) is preferably of the type of those comprising siloxyl units of formula:

$${H}_{d} {L}_{e} {SiO}_{\frac{4 - ( d + e )}{2}} \qquad ( IX )$$

in which:
L is a monovalent hydrocarbonaceous group which has no unfavourable effect on the activity of the catalyst and which is preferably chosen from alkyl groups having from 1 to 8 carbon atoms inclusive, advantageously from the methyl, ethyl, propyl and 3,3,3-trifluoropropyl groups, and as well from aryl groups, advantageously from the xylyl, tolyl and phenyl radicals,
d is 1 or 2, e is 0, 1 or 2, and d+e has a value of between 1 and 3,
optionally, at least a portion of the other units being units of mean formula:

$${L}_{g} {SiO}_{\frac{4 - g}{2}} \qquad ( X )$$

in which L has the same meaning as above and g has a value of between 0 and 3, preferably between 2 and 3.

The dynamic viscosity of this polyorganosiloxane is at least equal to 5, preferably to 10, and more preferably still is between 20 and 1000 mPa·s. The dynamic viscosity, referred to as “newtonian”, is the dynamic viscosity which is measured at 25° C., in a way known per se, at a shear rate gradient which is sufficiently low for the viscosity measured to be independent of the rate gradient.

Mention may be made, as examples of polyorganosiloxane (II), of poly(dimethylsiloxane)(methylhydrosiloxy)-α,ω-dimethylhydrosiloxane.

The polyorganosiloxane (II) can be formed solely of units of formula (IX) or additionally comprises units of formula (X).

The polyorganosiloxane (II) can exhibit a linear, branched, cyclic or network structure. The degree of polymerization is greater than or equal to 2. More generally, it is less than 5000.

The L group has the same meaning as the Z group above.

Examples of units of formula (IX) are:
H(CH₃)₂SiO_{1/2}, HCH₃SiO_{2/2}, H(C₆H₅)SiO_{2/2}

The examples of units of formula (X) are the same as those given above for the units of formula (VIII).

Examples of polyorganosiloxane (II) are:
dimethylpolysiloxanes comprising
   hydrodimethylsilyl ends,
copolymers comprising
   (dimethyl)hydromethylpolysiloxane (dimethyl) units comprising trimethylsilyl ends,
copolymers comprising
   (dimethyl)hydromethylpolysiloxane units comprising hydrodimethylsilyl ends,
hydromethylpolysiloxanes comprising
   trimethylsilyl ends,
cyclic hydromethylpolysiloxanes.

The ratio of the number of hydrogen atoms bonded to the silicon in the polyorganosiloxane (I) to the number of groups comprising alkenyl unsaturation of the polyorganosiloxane (II) is between 0.4 and 10, preferably between 0.6 and 5.

The polyorganosiloxane (I) and/or the polyorganosiloxane (II) can be diluted in a nontoxic organic solvent compatible with silicones.

The network polyorganosiloxanes (I) and (II) are commonly known as silicone resins.

The bases for polyaddition silicone compositions may comprise only linear polyorganosiloxanes (I) and (II), such as, for example, those disclosed in Patents: U.S. Pat. No. 3,220,972, U.S. Pat. No. 3,697,473 and U.S. Pat. No. 4,340,709, or may simultaneously comprise branched or network polyorganosiloxanes (I) and (II), such as, for example, those disclosed in Patents: U.S. Pat. No. 3,284,406 and U.S. Pat. No. 3,434,366.

According to a specific embodiment, the following are employed:
at least one linear polyorganosiloxane (I) comprising chains formed of units of formula (VIII) where c=2, blocked at each of their ends by units of formula (VII) where a=1 and b=2, and
at least one linear polyorganosiloxane (II) comprising, in its structure, at least three hydrogen atoms bonded to the silicon which are situated in the chains and/or at the chain ends;
and more preferably still,
at least one linear polyorganosiloxane (I) comprising chains formed of units of formula (VIII) where c=2, blocked at each of their ends by units of formula (VII) where a=1 and b=2, and
at least one linear polyorganosiloxane (II) comprising chains formed of units of formula (IX) where d=1 and e=1 and optionally of units of formula (X) where g=2, blocked at each of their ends by units of formula (IX) where d=1 and e=2.

The catalysts (III) are also well known. Use is preferably made of platinum and rhodium compounds. Use may in particular be made of the complexes of platinum and of an organic product disclosed in U.S. Pat. No. 3,159,601, U.S. Pat. No. 3,159,602 and U.S. Pat. No. 3,220,972 and European Patents EP-A-0 057 459, EP-A-0 188 978 and EP-A-0 190 530, of the complexes of platinum and of vinylated organosiloxanes disclosed in U.S. Pat. No. 3,419,593, U.S. Pat. No. 3,715,334, U.S. Pat. No. 3,377,432 and U.S. Pat. No. 3,814,730. The catalyst generally preferred is platinum. In this case, the amount by weight of catalyst (III), calculated as weight of platinum metal, is generally between 2 and 400 ppm, preferably between 5 amd 200 ppm, based on the total weight of the polyorganosiloxanes (I) and (II).

In accordance with a provision of the invention, the composition can be used for adhesive bonding. In the context of this application, it is possible and even recommended to add an adhesion promoter (IV) to the composition.

On the other hand, when the composition is used for moulding, the composition does not comprise an adhesion promoter.

The promoter (IV), when it is used, comprises:
(IV.1) at least one alkoxylated organosiloxane comprising, per molecule, at least one C₂-C₆ alkenyl group,
(IV.2) at least one organosilicon compound comprising at least one epoxy radical,
(IV.3) at least one metal M chelate and/or one metal alkoxide of general formula:
M(OJ)ₙ, with n=valency of M and
J=linear or branched C₂-C₆ alkyl.

Advantageously, the alkoxylated organosiloxane (IV.1) corresponds to the following general formula: 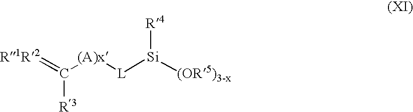
in which:
R″¹, R′² and R′³ are hydrogen or hydrocarbonaceous radicals which are identical to or different from one another and preferably represent hydrogen, a linear or branched C₁-C₄ alkyl or a phenyl optionally substituted by at least one C₁-C₃ alkyl,
A is a linear or branched C₁-C₄ alkylene or a divalent group of formula —CO—O-alkylene_{▪}, where the alkylene residue is as defined above and the valency _{▪} is bonded to the Si via G,
L is a valency bond or oxygen,
R′⁴ and R′⁵ are identical or different radicals and represent a linear or branched C₁-C₄ alkyl,
x′=0 or 1,
x=0 to 4, preferably 0 or 1 and more preferably still 0.

Without this being limiting, it may be considered that vinyltrimethoxysilane is a particularly appropriate compound (IV.1).

The organosilicon compound (IV.2) of the promoter (IV) is chosen:
either from the products (IV.2a) of following general formula: 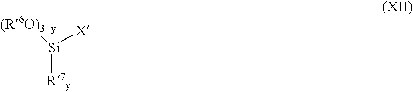
in which:
R′⁶ is a linear or branched C₁-C₄ alkyl radical,
R′⁷ is a linear or branched alkyl radical,
y is equal to 0, 1, 2 or 3, preferably to 0 or 1 and more preferably still to 0,
X′ is equal to: 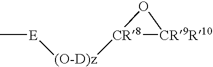
with
   E and D being identical or different radicals chosen from linear or branched C₁-C₄ alkylenes,
   z being equal to 0 or 1,
   R′⁸, R′⁹ and R′¹⁰ being identical or different radicals representing hydrogen or a linear or branched C₁-C₄ alkyl, hydrogen being more particularly preferred,
   it being possible for R′⁸, R′⁹ and R′¹⁰ alternatively to constitute, together with the two carbons carrying the epoxy, an alkyl ring having from 5 to 7 ring members,
or from the products (IV.2b) composed of epoxyfunctional polydiorganosiloxanes comprising at least one unit of formula:

$${X}_{p}^{′} {G}_{q} {SiO}_{\frac{4 - ( p - q )}{2}} \qquad ( XIII )$$
in which:
X′ is the radical as defined above for the formula (XII),
G is a monovalent hydrocarbonaceous group which has no unfavourable effect on the activity of the catalyst and which is preferably chosen from alkyl groups having from 1 to 8 carbon atoms inclusive, advantageously from the methyl, ethyl, propyl and 3,3,3-trifluoropropyl groups, and as well from aryl groups, advantageously from the xylyl, tolyl and phenyl radicals,
p=0, 1 or 2,
q=1, 2 or 3,
p+q=0, 1, 2 or 3,
optionally at least a portion of the other units of these polydiorganosiloxanes being units of mean formula:

$${G}_{r} {SiO}_{\frac{4 - r}{2}} \qquad ( XIV )$$
in which G has the same meaning as above and r has a value of between 0 and 3, for example between 1 and 3.

The compounds (IV.2) are thus preferably epoxyalkoxysililcon compounds and more preferably still epoxyalkoxymonosilanes (IV.2a).

Mention may be made, as examples of such compounds (IV.2), of:
-3-glycidoxypropyltrimethoxysilane (GLYMO)
or 3,4-epoxycyclohexylethyltrimethoxysilane.

As regards the final essential compound (IV.3) of the adhesion promoter (IV), the preferred products are those in which the metal M of the chelate and/or of the alkoxide (IV.3) is chosen from the following list: Ti, Zr, Ge, Li and Mn. It should be emphasized that titanium is more particularly preferred. An alkyl radical of butyl type, for example, can be combined with it.

In practice, the adhesion promoter (IV) is, for example:

vinyltrimethoxysilane (VTMO)(IV.1),
3-glycidoxypropyltrimethoxysilane (GLYMO)(IV.2),
and butyl titanate (IV.3).

Quantitatively, it may be specified that the proportions by weight between (IV.1), (IV.2) and (IV.3), when an adhesion promoter is used, expressed as percentages by weight with respect to the total of the three, are as follows:
(IV.1) of between 15 and 70 and preferably between 30 and 50,
(IV.2) of between 15 and 70 and preferably between 30 and 50,
(IV.3) of between 5 and 25 and preferably between 10 and 20,
   it being understood that the sum of these proportions of (IV.1), (IV.2) and (IV.3) is equal to 100%.

The filler (V) employed is composed of products chosen from siliceous (or nonsiliceous) materials.

As regards the siliceous materials, they can act as reinforcing or semi-reinforcing filler.

The reinforcing siliceous fillers are chosen from colloidal silicas, fumed and precipitated silica powders, or their mixtures.

These powders exhibit a mean particle size generally of less than 0.1 μm and a BET specific surface of greater than 50 m²/g, preferably of between 100 and 350 m²/g.

Semi-reinforcing siliceous fillers, such as diatomaceous earths or ground quartz, can also be employed.

As regards the nonsiliceous inorganic materials, they can be involved as semi-reinforcing or bulking inorganic filler. Examples of these nonsiliceous fillers, which can be used alone or as a mixture, are carbon black, titanium dioxide, aluminium oxide, alumina hydrate, expanded vermiculite, nonexpanded vermiculite, calcium carbonate, zinc oxide, mica, talc, zirconates, iron oxide, barium sulphate and slaked lime. These fillers have a particle size generally of between 0.001 and 300 μm and a BET specific surface of less than 100 m²/g.

In practice but without implied limitation, the filler employed is quartz or a mixture of quartz and silica.

The filler can be treated by all or part of at least one and/or other of the compounds (IV.1) to (IV.3) of the promoter (IV).

In the case in particular of the use of a particulate siliceous inorganic filler, the filler can advantageously be employed in the form of the suspension obtained by treating the filler Dv application of the method in accordance with the teaching of Patent Application WO-A-98/58997, which provides a two-step treatment of the filler by a compatibilizing agent (chosen for example: as regards the first treatment step, from a silazane, a hydroxylated siloxane, an amine or an organic acid; and, as regards the second treatment step, from a silazane), the treatment being carried out in the presence of the POS (I) constituent. In the case where such treatment results in a basic pH, a neutralizing agent, such as, for example, a weak acid or a silica filler, such as ground quartz, can be added to the dispersion.

As far as the weight is concerned, it is preferable to employ an amount of filler of between 20 and 50%, preferably between 25 and 35%, by weight with respect to the combined constituents of the composition.

Advantageously, the silicone elastomer composition comprises at least one retardant (VI) of the addition reaction (crosslinking inhibitor) chosen from the following compounds:
polyorganosiloxanes which are advantageously cyclic and substituted by at least one alkenyl, tetramethylvinyltetrasiloxane being particularly preferred,
pyridine,
organic phosphites and phosphines,
unsaturated amides,
alkyl maleates
and acetylenic alcohols.

These acetylenic alcohols (cf. FR-B-1 528 464 and FR-A-2 372 874), which are among the preferred thermal blockers of the hydrosilylation reaction, have the formula:
R¹⁵—(R¹⁶)C(OH)C≡CH
in which formula:
R¹⁵ is a linear or branched alkyl radical or a phenyl radical;
R¹⁶ is H, a linear or branched alkyl radical or a phenyl radical;
   it being possible for the R¹⁵ and R¹⁶ radicals and the carbon atom situated a to the triple bond optionally to form a ring;
   the total number of carbon atoms present in R¹⁵ and R¹⁶ being at least 5, preferably from 9 to 20.

The said alcohols are preferably chosen from those exhibiting a boiling point of greater than 250° C. Mention may be made, by way of examples, of:
1-ethynyl-1-cyclohexanol;
3-methyldodec-1-yn-3-ol;
3,7,11-trimethyldodec-1-yn-3-ol;
1,1-diphenylprop-2-yn-1-ol;
3-ethyl-6-ethylnon-1-yn-3-ol;
3-methylpentadec-1-yn-3-ol.

These α-acetylenic alcohols are commercial products.

Such a retardant (VI) is present in a proportion of at most 3000 ppm, preferably in a proportion of 100 to 2000 ppm, with respect to the total weight of the organopolysiloxanes (I) and (II).

The composition used according to the invention can comprise at least one unsaturated POS resin (VII) comprising at least two alkenyl residues, preferably vinyl residues, per molecule.

Advantageously, the POS resin (VII) comprises, in its structure, from 0.1 to 20% by weight of alkenyl group(s), the said structure exhibiting at least two different units chosen from units of M, D, T and Q types, at least one of these units being a unit of T or Q type.

In practice, this resin (VII) preferably corresponds to one of the three following formulae:
MM^{Vi}DD^{Vi}Q (XV)
or
MD^{Vi}Q (XVI)
or
MM^{Vi}Q (XVII)

This resin (VII) participates in the establishment of the rheological, mechanical and adhesive properties of the composition. It is known that the Q siloxyl units play a relatively important role in this respect. Thus, in accordance with an advantageous provision of the invention, the resin (VII) comprises Q units in a proportion of at least 5% preferably at least 7%, and more preferably still in a proportion of 8 to 30%.

According to an alternative form, the resin (VII) comprises T siloxyl units.

In a way known per se, the silicone elastomer composition can have added to it various conventional additives, such as, for example, colorants.

More advantageously still, the composition according to the invention comprises at least one reinforcing filler, such as a silicic filler, or a paste.

According to a particularly preferred embodiment, the composition used according to the invention involves the constituents (I) to (VIII) in the following proportions, as % by weight on a dry basis with respect to the total weight:

| | | | |
|---|---|---|---|
| (I) | 1 to 80 | preferably | 10 to 60 |
| (II) | 0.1 to 20 | preferably | 0.5 to 10 |
| (III) | 0.0002 to 0.04 | preferably | 0.0005 to 0.02 |
| (IV.1) | 0.01 to 5 | preferably | 0.05 to 2 |
| (IV.2) | 0.01 to 5 | preferably | 0.05 to 2 |
| (IV.3) | 0.01 to 3 | preferably | 0.1 to 1 |
| (V) | 0 to 90 | preferably | 10 to 80 |
| (VI) | 0 to 0.5 | preferably | 0.005 to 0.3 |
| (VII) | 0 to 80 | preferably | 5 to 70 |
| (VIII) | 0.2 to 5 | preferably | 0.5 to 2. |

According to another of its aspects, the present invention relates to a two-component precursor system of the silicone elastomer composition described above.

Such a precursor system is provided in two separate parts A and B intended to be mixed to form the composition, one of these parts A or B comprising the catalyst (III) and a single polyorganosiloxane entity (I) or (II). Another characteristic of this precursor system is that its part A or B comprising the compound (IV.1) of the promoter (IV) does not comprise the catalyst (III), that the resin (VII) can be employed in the part A or the part B or in both parts A and B, the part A or B comprising the POS (II) and the resin (VII) being devoid of catalyst (III), and, finally, that the thixotropic compound (VIII) can be employed in the part A or B comprising the catalyst (III).

The viscosity of the parts A and B and of their mixture can be adjusted by varying the amounts of the constituents and by choosing polyorganosiloxanes of different viscosities.

Once mixed with one another, the parts A and B form a ready-for-use silicone elastomer composition which can be applied to the substrates to be adhesively bonded or to be coated by an appropriate means (for example, doctor blade, nozzle, gun, brush, screen printing, and the like).

The composition applied to the support to be coated can be crosslinked thermally and/or by infrared radiation.

According to a noteworthy characteristic of the use according to the invention, the substrates which can be adhesively bonded by the composition are made of thermoplastic or thermosetting polymer, preferably of phenoplast, of polyamide, of polyester, of ABS, of polycarbonate, of PVC, of polyether, of polyolefin or of epoxy resin.

The substrates can also be metal substrates. They can, e.g., be: raw or treated aluminiums, raw or treated steels, or enamelled metals.

Thus it is that the composition according to the invention is self-adhesive on aluminium (type AG3) and on steel (type Sollac R 1426) with a shear strength of 1 to 5 MPa and 100% cohesive failure in all cases.

The field of application of the use recommended by the invention is advantageously that of the adhesive bonding of components for the construction of vehicles, in particular motor vehicles, or that of the adhesive bonding of components for the construction of domestic electrical appliances, in particular electric irons.

In practice, the adhesive bonding applications in the automobile industry can be:
flexible adhesive bonding of plastic and metal components under the engine bonnet and in the passenger compartment,
adhesive bonding of headlamp units.

According to an alternative form, this field of application can also be that of the adhesive bonding of electrical/electronic components, in particular in the domestic electrical appliance industry.

According to another alternative form, the field of application can also be that of the moulding of forms to be reproduced. This is because the low dripping of the composition according to the invention confers thereon a very particular advantage for its application with regard to components or substrates to be reproduced and thus which have to be moulded.

The examples which follow describe the preparation of the crosslinkable silicone composition according to the invention. These examples will allow its advantages to emerge. They refer to the drawings, in which:

FIG. 1 represents the curve of the change in the viscosity and in the Bingham threshold of a composition, the part A of the two-component system, comprising 2.5% of 200 m²/g silica pretreated and additivated with a POS oil comprising a piperidinyl functional group,

FIG. 2 represents the curve of the change in the viscosity and in the Bingham threshold of a composition, the part A of the two-component system, comprising 10% of a dispersion of silica treated in situ and additivated with a POS oil comprising a piperidinyl functional group.

### EXAMPLES

### Example 1

### Formulation of the Parts A and B of a Two-Component Crosslinkable Silicone Composition

Part A of the Two-Component System

The following are mixed in a reactor at ambient temperature:
41.6 parts by weight of a resin of type (VII) MM^{Vi}DD^{Vi}Q comprising 0.9% by weight of vinyl (Vi) groups and composed of 21% by weight of (CH₃)₃SiO_{0.5} units, 0.2% by weight of (CH₃)₂ViSiO_{0.5} units, 67.8% by weight of (CH₃)₂SiO units, 3% by weight of (CH₃)ViSiO units and 8% by weight of SiO₂ units
24.8 parts by weight of a PDMS oil (I), blocked by (CH₃)₂ViSiO_{0.5} units, having a viscosity of 100 000 mPa·s and comprising 0.005 SiVi functional group per 100 g of oil
32.9 parts by weight of inorganic filler (V), in the form of ground quartz with a mean particle size of approximately 2 μm
0.7 part by weight of tetrabutyl orthotitanate (TBOT) (IV.3)
0.004 part by weight of platinum (III) metal in the form of a metal complex known under the name of Karstedt catalyst.
   Part B of the Two-Component System

The following are mixed in a reactor at ambient temperature:
26.8 parts by weight of a resin (VII) with the structure MM^{Vi}DD^{Vi}Q comprising 0.9% by weight of vinyl (Vi) groups and composed of 21% by weight of (CH₃)₃SiO_{0.5} units, 0.2% by weight of (CH₃)₂ViSiO_{0.5} units, 67.8% by weight of (CH₃)₂SiO units, 3% by weight of (CH₃)ViSiO units and 8% by weight of SiO₂ units
14.1 parts by weight of PDMS oil (I), blocked by (CH₃)₂ViSiO_{0.5} units, having a viscosity of 100 000 mPa·s and comprising 0.005 SiVi functional group per 100 g of oil
49 parts by weight of inorganic filler (V), in the form of ground quartz, with a mean particle size of approximately 2 μm
2.5 parts by weight of 200 m²/g silica pretreated with a cyclic POS
3.9 parts by weight of a poly(dimethyl)(hydromethyl)siloxane (II), blocked by (CH₃)₂HSiO_{0.5} units, having a viscosity of 25 mPa·s and comprising, in total, 0.7 SiH functional group per 100 g of oil
0.05 part by weight of ethynylcyclohexanol (VI)
1.8 parts by weight of vinyltrimethoxysilane (VTMO) (IV.1)
1.8 parts by weight of γ-glycidoxypropyltrimethoxysilane (GLYMO) (IV.2)
0.1 part by weight of black colouring base.

The two-component system is obtained by mixing 100 parts of A and 100 parts of B at ambient temperature.

### Example 2

### Rheological and Mechanical Properties of the Part A of the Two-Component System Additivated with a POS Oil Comprising a Piperidinyl Functional Group (VIII)

For the laboratory evaluations, the product is employed from a compressed-air spray gun which makes it possible to extrude the product present in two-component cartridges (2×200 cc): the mixing is carried out using a static mixer placed immediately at the outlet of the cartridge.

The rheological and mechanical properties are evaluated by additivation of the part A of the two-component system with a POS oil comprising a piperidinyl functional group (VIII). The part B remains identical. The POS comprising a piperidinyl functional group is of formula: 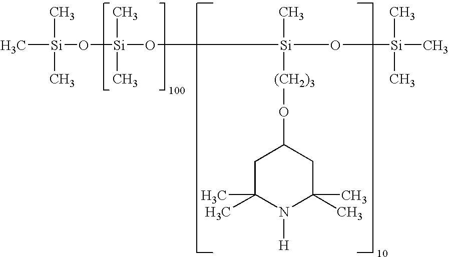
in the form of an oil with a viscosity of approximately 10 000 mPa·s comprising 0.25% by weight of nitrogen. This oil is added to the part A of the two-component system at 0.5 (Test 1), 1 (Test 2) and 2% (Test 3). The mixture is homogenized by hand using a spatula. The rheological and mechanical performances of the composition thus obtained are measured in the following way:
the Theological properties were measured on a CarriMed rheometer with a cone of diameter 2.0 cm and an angle of 1°.
the yield point is determined by the computer of the device by applying a Bingham fluid model.
the mechanical properties were measured on H2 test specimens. To do this, a film with a thickness of 2 mm is produced: the product is crosslinked at 150° C. for 1 hour under a heating press. The test specimens are subsequently removed, a shore A hardness measurement is carried out and then the mechanical properties (tensile strength, modulus, elongation) are evaluated using a dynamometer of Zwick type with a pull rate of 500 mm/min.

The results of these tests are combined in Table 1 below:

TABLE 1

| | | Test 1 | Test 2 | Test 3 |
|---|---|---|---|---|
| | Control | 0.5% | 1% | 2% |
| Viscosity (Pa · s) | 100 000 | 102 000 | 104 000 | 100 000 |
| Bingham threshold (PA) | 45 | 85 | 118 | 132 |
| Tensile strength | 5.6 | 5 | 4.9 | 5 |
| T/S (MPa) | | | | |
| Elongation at break | 264 | 239 | 246 | 271 |
| E/B (%) | | | | |
| 100% Modulus (MPa) | 2.1 | 2.2 | 2.1 | 2 |
| Shore hardness A 3 × 2 mm | 44.1 | 44.7 | 46.5 | 41.5 |

These results show that the addition of the POS oil comprising a piperidinyl functional group has an effect on the Theological properties of the part A of the two-component system. Specifically, the greater the content of oil, the greater the yield point. On the other hand, it is found that the addition of oil does not have any significant effect on the viscosity of the composition A or on the mechanical properties of the two-component system.

### Example 3

### Rheological and Mechanical Properties of the Part A of the Two-Component System Comprising 2.5% of 200 m²/g Silica Pretreated and Additivated with a POS Comprising a Piperidinyl Functional Group as Thixotropic Additive

The preceding example is repeated, except that 2.5% of pretreated 200 m²/g silica are added to the particle A as reinforcing filler.

The results of the tests are combined in Table 2 below:

TABLE 2

| | | Test 4 | Test 5 | Test 6 |
|---|---|---|---|---|
| | Control | 0.5% | 1% | 2% |
| Viscosity (Pa · s) | 75 000 | 80 000 | 75 000 | 82 000 |
| Bingham threshold (PA) | 75 | 165 | 250 | 320 |
| Tensile strength | 5.9 | 5.9 | 5.8 | 5.2 |
| T/S (MPa) | | | | |
| Elongation at break | 243 | 232 | 260 | 251 |
| E/B (%) | | | | |
| 100% Modulus (MPa) | 2.9 | 2.9 | 2.5 | 2.3 |
| Shore hardness A 3 × 2 mm | 49.7 | 50 | 47.5 | 48.1 |

The results show that, in the presence of silica in the composition of the part A, the effect of the POS oil comprising a piperidinyl functional group (VIII) on the yield point is reinforced with respect to the action of the same oil on a silica-free composition as presented in Example 2. In the same way as in Example 2, the viscosity of the composition and the mechanical properties of the two-component system are not significantly modified by the addition of the oil.

### Example 4

### Rheological and Mechanical Properties of the Part A of the Two-Component System Comprising Various Levels of Dispersion of Silica Treated In Situ and Additivated with a POS Comprising a Piperidinyl Functional Group

Example 2 is repeated, except that different parts A, each comprising a different level of reinforcing filler contributed by the dispersion of silica, are prepared. The POS oil comprising a piperidinyl functional group as defined in Example 2 is added to each of these compositions at levels of 0.5, 1 and 2%.

The dispersion of silica treated in situ is obtained in the following way: The following are introduced into a Z-arm laboratory mixer:
74 parts of (CH₃)ViSiO_{0.5}-terminated PDMS with a viscosity of 600 mPa·s,
2 parts of water,
30 parts of silica with an expanded surface of 200 m²/g.
   After incorporation, 5 parts of hexamethyldisilazine are added. Mixing is continued for 1 hour, before heating the reactor in order to gradually remove the volatile compounds.

The results obtained with a part A comprising 10% of dispersion of silica treated in situ are combined in Table 3:

TABLE 3

| | | Test 7 | Test 8 | Test 9 |
|---|---|---|---|---|
| | Control | 0.5% | 1% | 2% |
| Viscosity (Pa · s) | 80 000 | 82 000 | 81 000 | 83 000 |
| Bingham threshold (PA) | 51 | 125 | 155 | 165 |
| Tensile strength | 6.5 | 6 | 5.6 | 5.6 |
| T/S (MPa) | | | | |
| Elongation at break | 200 | 222 | 212 | 196 |
| E/B (%) | | | | |
| 100% Modulus (MPa) | 3.28 | 2.8 | 2.7 | 3 |
| Shore hardness A 3 × 2 mm | 46.5 | 50.3 | 48 | 49.5 |

The results obtained with a part A comprising 15% of dispersion of silica treated in situ are combined in Table 4:

TABLE 4

| | | Test 10 | Test 11 | Test 12 |
|---|---|---|---|---|
| | Control | 0.5% | 1% | 2% |
| Viscosity (Pa · s) | 84 000 | 91 000 | 80 000 | 81 000 |
| Bingham threshold (PA) | 65 | 148 | 210 | 250 |
| Tensile strength | 6.7 | 6.2 | 6.1 | 5.4 |
| T/S (MPa) | | | | |
| Elongation at break | 176 | 204 | 198 | 217 |
| E/B (%) | | | | |
| 100% Modulus (MPa) | 4 | 3 | 3.2 | 2.4 |
| Shore hardness A 3 × 2 mm | 49.7 | 52 | 51.5 | 47.3 |

The results obtained with a part A comprising 20% of dispersion of silica treated in situ are combined in Table 5:

TABLE 5

| | | Test 13 | Test 14 | Test 15 |
|---|---|---|---|---|
| | Control | 0.5% | 1% | 2% |
| Viscosity (Pa · s) | 112 000 | 104 000 | 106 000 | 107 000 |
| Bingham threshold (PA) | 100 | 225 | 300 | 350 |
| Tensile strength | 6.7 | 6.1 | 6.1 | 5.6 |
| T/S (MPa) | | | | |
| Elongation at break | 192 | 191 | 156 | 166 |
| E/B (%) | | | | |
| 100% Modulus (MPa) | 3.5 | 3.3 | 4.2 | 3.9 |
| Shore hardness A 3 × 2 mm | 53.5 | 52.5 | 56.7 | 55.5 |

The results in Table 3 show that, in the presence of dispersion of silica treated in situ in the part A of the two-component system, the effect of the POS oil comprising a piperidinyl functional group (VIII) on the yield point is reinforced with respect to the action of the same oil on a composition without silica dispersion as presented in Example 2.

Comparison of the results in Tables 3, 4 and 5 shows that the yield point increases in proportion as the level of silica dispersion in the part A of the two-component system increases.

The mechanical properties and the viscosity of the two-component system with various levels of paste formation are not modified with the addition of the POS oil comprising a piperidinyl functional group.

### Example 5

### Study of the Change Over Time in the Rheological Properties of the Part A of the Two-Component System Comprising 2.5% of Pretreated 200 m²/g Silica and Additivated with a POD Comprising a Piperidinyl Functional Group

The various compositions described in Example 2 have formed the subject of a measurement of viscosity and of Bingham threshold after storage for 0, 2, 7, 21, 50, 80 and 120 days, in order to study the change over time in the rheological properties of the additivated compositions with respect to the control composition and thus to determine the effects of the POS oil comprising a piperidinyl functional group after storage.

This change is represented in the form of curves in FIG. 1. In this figure, the solid curves are the viscosity curves while the dotted curves are those of the Bingham threshold. The key to the various symbols is as follows:
▪ control (part A comprising 2.5% of pretreated 200 m²/g silica)
♦ part A comprising 2.5% of pretreated 200 m²/g silica and 0.5% of POS oil comprising a piperidinyl functional group
● part A comprising 2.5% of pretreated 200 m²/g silica and 1% of POS oil comprising a piperidinyl functional group
[symbol] part A comprising 2.5% of pretreated 200 m²/g silica and 2% of POS oil comprising a piperidinyl functional group.

It is found that the change over time of the various additivated parts A is entirely equivalent to that of the nonadditivated control part A. The POS oil comprising a piperidinyl functional group therefore has no effect over time on the part A of the two-component system which comprises pretreated 200 m²/g silica as additive. The part A of the two-component system according to the invention thus exhibits rheological properties which are stable over time.

### Example 6

### Study of the Change Over Time in the Rheological Properties of the Part A of the Two-Component System Comprising 10% of Dispersion of Silica Treated In Situ and Additivated with a POD Comprising a Piperidinyl Functional Group

Example 5 is repeated, except that the parts A are equivalent to those tested in Example 4 and comprise only a single level of silica dispersion at 10%.

The change over time in the rheological properties of the various compositions is represented in FIG. 2. In this figure, the solid curves are the viscosity curves while the dotted curves are those of the Bingham threshold. The key to the various symbols is as follows:
▪ control (part A comprising 10% of dispersion of silica treated in situ)
♦ part A comprising 10% of dispersion of silica treated in situ and 0.5% of POS oil comprising a piperidinyl functional group
[symbol] part A comprising 10% of dispersion of silica treated in situ and 1% of POS oil comprising a piperidinyl functional group
● part A comprising 10% of dispersion of silica treated in situ and 2% of POS oil comprising a piperidinyl functional group.

As in Example 5, it is found that the change over time of the various additivated parts A is entirely equivalent to that of the nonadditivated control part A. The POS oil comprising a piperidinyl functional group therefore has no effect over time on the part A of the two-component system which comprises the dispersion of silica treated in situ as additive.

The examples presented show that the composition developed by the Applicant exhibits improved Theological properties, while retaining a viscosity which makes it possible for it to be easily handled, and first-rate mechanical properties. The use of reinforcing fillers significantly improves the rheological properties since the value of the yield point is multiplied by 4, this being achieved without modifying the viscosity or the mechanical properties. Finally, the composition according to the invention, and in particular the part A constituting it, has very good stability over time.

1-20. (Canceled)

21. A crosslinkable adhesive silicone composition comprising:
(I) at least one polyorganosiloxane exhibiting, per molecule, at least two alkenyl groups bonded to the silicon,
(II) at least one polyorganosiloxane exhibiting, per molecule, at least three hydrogen atoms bonded to the silicon,
(III) a catalytically effective amount of at least one catalyst composed of at least one metal belonging to the platinum group,
(IV) optionally, an adhesion promoter,
(V) a reinforcing or non-reinforcing inorganic filler,
(VI) optionally, at least one crosslinking inhibitor,
(VII) optionally, at least one polyorganosiloxane resin carrying Q and/or T siloxyl units and alkenyl groups, and
(VIII) at least one compound comprising a cyclic amine functional group carried on a siloxane chain, as thixotropic additive which modifies the rheological properties of the composition by conferring thereon a high yield point.

22. The composition according to claim 21, wherein the cyclic amine functional group of the compound (VIII) is a piperidinyl functional group.

23. The composition according to claim 21, wherein the compound (VIII) is a polyorganosiloxane having, per mole, at least one unit of general formula:
$${( R )}_{a} {( X )}_{b} Z Si {( O )}_{\frac{3 - ( a + b )}{2}} \qquad ( I )$$
wherein:
the R symbols are identical or different and represent a monovalent hydrocarbon radical selected from the group consisting of a linear or branched alkyl radical having from 1 to 4 carbon atoms, a phenyl radical and a 3,3,3-trifluoropropyl radical;
the X symbols are identical or different and represent a monovalent radical selected from the group consisting of a hydroxyl group, an alkenyl radical and an alkoxy radical having from 1 to 3 carbon atoms;
Z represents a group having sterically hindered piperidinyl group(s) selected from the group consisting of:
a) groups of formula: 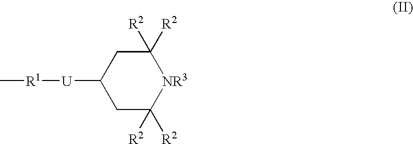
wherein:
R¹ is a linear or branched alkylene radical having from 2 to 18 carbon atoms; an alkylenecarbonyl radical whose linear or branched alkylene part has 2 to 20 carbon atoms; an alkylenecyclohexylene radical, whose linear or branched alkylene part has from 2 to 12 carbon atoms and the cyclohexylene part has an —OH group and, optionally, 1 or 2 alkyl radicals having from 1 to 4 carbon atoms; a radical of formula —R⁴—O—R⁵— wherein the R⁴ and R⁵ radicals, identical or different, represent alkylene radicals having 1 to 12 carbon atoms; a radical of formula —R⁴—O—R⁵— wherein the R⁴ and R⁵ radicals have the meanings indicated above and one or both of them are substituted by one or two OH group(s); a radical of formulae —R⁴—COO—R⁵— and —R⁴—OCO—R⁵— wherein R⁴ and R⁵ have the above meanings; or a radical of formula —R⁶—O—R⁷—O—CO—R⁸— wherein R⁶, R⁷ and R⁸, identical or different, represent alkylene radicals having from 2 to 12 carbon atoms and the R⁷ radical is optionally substituted by a hydroxyl group;
U represents —O— or —NR⁹—, R⁹ being a hydrogen atom; a linear or branched alkyl radical having from 1 to 6 carbon atoms; a divalent radical —R¹— which has the meaning indicated above, one of the valency bonds being connected to the nitrogen atom of —NR⁹— and the other being connected to a silicon atom; or a divalent radical of formula: 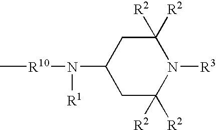
wherein R¹ has the meaning indicated above, R² and R³ have the meanings indicated below and R¹⁰ represents a linear or branched alkylene radical having 1 to 12 carbon atoms, one of the valency bonds (that of R¹⁰) being connected to the nitrogen atom of —NR⁹— and the other (that of R¹) being connected to a silicon atom;
R² identical or different are from linear or branched alkyl radicals having from 1 to 3 carbon atoms or a phenyl radical;
R³ represents a hydrogen atom or the R² radical; and
b) groups of formula: 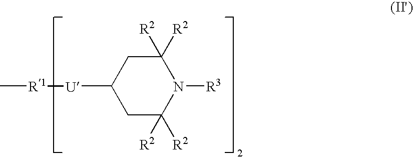
wherein:
R′¹ is a trivalent radical of formula: 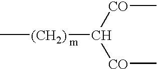
wherein m represents a number from 2 to 20,
Or a trivalent radical of formula: 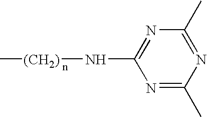
wherein n represents a number from 2 to 20;
U′ represents —O— or —NR¹¹, R¹¹ being a hydrogen atom or a linear or branched alkyl radical having from 1 to 6 carbon atoms;
R² and R³ have the same meanings as those given with respect to the formula (II);
a is a number chosen from 0, 1 and 2;
b is a number chosen from 0, 1 and 2; and
a+b is at most equal to 2.

24. The composition according to claim 23, wherein the polyorganosiloxane (VIII) further comprises at least one other siloxyl unit of formula:
$${( R )}_{c} {( X )}_{d} {V Si ( O )}_{\frac{3 - ( c + d )}{2}} \qquad ( III )$$
wherein:
the R and X symbols have the same meanings as those given above with respect to the formula (I);
the V symbol represents: a linear or branched alkyl radical having from 5 to 20 carbon atoms; a radical of formula —(CH₂)ₚ—COO—R¹² wherein p represents a number from 5 to 20 and R¹² represents a linear or branched alkyl radical having from 1 to 12 carbon atoms; a radical of formula —(CH₂)_{q}—O—R¹³ wherein q represents a number from 3 to 10 and R¹³ represents a hydrogen atom, an ethylene oxide sequence, a propylene oxide sequence, a mixed ethylene oxide+propylene oxide sequence or an acyl radical having from 2 to 12 carbon atoms;
c is a number chosen from 0, 1 and 2;
d is a number chosen from 0, 1 and 2; and
c+d is at most equal to 2.

25. The composition according to claim 23, wherein the polyorganosiloxane (VIII) further comprises other siloxyl unit(s) of formula:
$${( R )}_{e} {( X )}_{f} {Si ( O )}_{\frac{4 - ( e + f )}{2}} \qquad ( IV )$$
wherein:
R and X have the same meanings as those given with respect to the formula (I);
e is a number chosen from 0, 1, 2 and 3;
f is a number chosen from 0, 1, 2 and 3; and
e+f is at most equal to 3.

26. The composition according to claim 23, wherein the polyorganosiloxane (VIII) is a linear polydiorganosiloxane of mean formula: 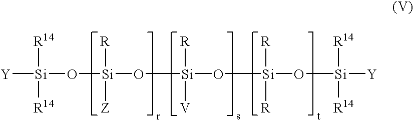
wherein:
the R, Z and V symbols have the meanings given above with respect to the formulae (I) and (III);
the Y symbol represents a monovalent radical chosen from the R, Z, V and X radicals;
the R¹⁴ symbols are identical or different and represent a monovalent radical chosen from an R radical and an X radical as defined above with respect to the formula (I);
and r, s and t are equal to zero or represent integers or fractional numbers of greater than zero, with the further proviso that, if r=0, at least one of the two Y radicals represents the Z radical.

27. The composition according to claim 21, wherein the compound (VIII) corresponds to the following formula: 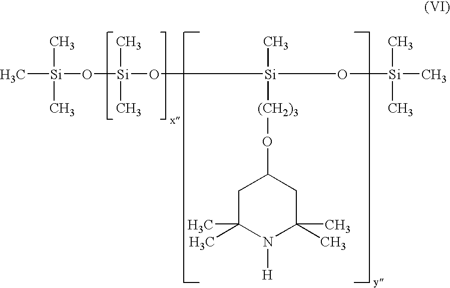
wherein:
x″ is between 0 and 1000,
y″ is between 1 and 50, and
with a proportion by weight of the compound of formula (VI) in the composition optionally being between 0.2 and 5%.

28. The composition according to claim 21, wherein the polyorganosiloxane (I) exhibits units of formula:
$${W}_{a} {Z}_{b}^{′} Si {O}_{\frac{4 - ( a + b )}{2}} \qquad ( VII )$$
wherein:
W is an alkenyl group, preferably a vinyl or allyl group,
Z′ is a monovalent hydrocarbonaceous group having no unfavourable effect on the activity of the catalyst and is optionally an alkyl group having from 1 to 8 carbon atoms inclusive, or an aryl group,
a is 1 or 2, b is 0, 1 or 2, and a+b is between 1 and 3, and
optionally, at least a portion of the other units being units of mean formula:
$${Z}_{c}^{′} Si {O}_{\frac{4 - c}{2}} \qquad ( VIII )$$
wherein Z′ has the same meaning as above and c has a value of between 0 and 3.

29. The composition according to claim 21, wherein the polyorganosiloxane (II) comprises siloxyl units of formula:
$${H}_{d} {L}_{e} Si {O}_{\frac{4 - ( d + e )}{2}} \qquad ( IX )$$
wherein:
L is a monovalent hydrocarbon group having no unfavourable effect on the activity of the catalyst and optionally being an alkyl group having from 1 to 8 carbon atoms inclusive, or an aryl group,
d is 1 or 2, e is 0, 1 or 2, and d+e has a value of between 1 and 3, and
optionally, at least a portion of the other units being units of mean formula:
$${L}_{g} Si {O}_{\frac{4 - g}{2}} \qquad ( X )$$
wherein L has the same meaning as above and g has a value of between 0 and 3.

30. The composition according to claim 21, wherein the promoter (IV) comprises:
(IV.1) at least one alkoxylated organosiloxane having, per molecule, at least one C₂-C₆ alkenyl group,
(IV.2) at least one organosilicon compound having at least one epoxy radical, and
(IV.3) at least one metal M chelate or one metal alkoxide of general formula: M(OJ)ₙ, with n is the valency of M and J is a linear or branched C₂-C₆ alkyl.

31. The composition according to claim 30, wherein the alkoxylated organosiloxane (IV.1) of the promoter (IV) corresponds to the following general formula: 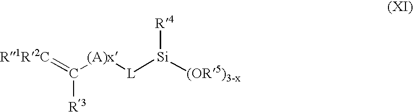
wherein:
R″¹, R′² and R′³, identical or different, are hydrogen or hydrocarbon radicals,
A is a linear or branched C₁-C₄ alkylene or a divalent group of formula —CO—O-alkylene, where the alkylene group is as defined above and the valency is bonded to the Si via G,
L is a valency bond or oxygen,
R′⁴ and R′⁵ are identical or different radicals and represent a linear or branched C₁-C₄ alkyl,
x′=0 or 1, and
x=0 to 4.

32. The composition according to claim 30, wherein the organosilicon compound (IV.2) of the promoter (IV) is:
a product (IV.2a) of following general formula: 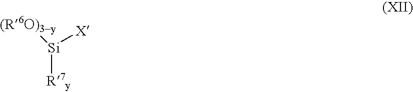
wherein:
R′⁶ is a linear or branched C₁-C₄ alkyl radical,
R′⁷ is a linear or branched alkyl radical,
y is equal to 0, 1, 2 or 3, and
X′ is equal to: 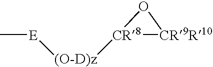
wherein:
E and D identical or different radicals are linear or branched C₁-C₄ alkylenes,
z is equal to 0 or 1,
R′⁸, R′⁹ and R′¹⁰ identical or different represent hydrogen or a linear or branched C₁-C₄ alkyl, optionally, R′⁸, R′⁹ and R′¹⁰ constitute, together with the two carbons carrying the epoxy, an alkyl ring having from 5 to 7 ring members,
or a product (IV.2b) being an epoxyfunctional polydiorganosiloxane having at least one unit of formula:
$${X}_{p}^{′} {G}_{p} Si {O}_{\frac{4 - ( p + q )}{2}} \qquad ( XIII )$$
wherein:
X′ is the radical as defined above for the formula (XII),
G is a monovalent hydrocarbon group which has no unfavourable effect on the activity of the catalyst and which is an alkyl group having from 1 to 8 carbon atoms inclusive, or an aryl group,
p=0, 1 or 2,
q=1, 2 or 3,
p+q=0, 1, 2 or 3, and
optionally at least a portion of the other units of these polydiorganosiloxanes being units of mean formula:
$${G}_{r} Si {O}_{\frac{4 - r}{2}} \qquad ( XIV )$$
wherein G has the same meaning as above and r has a value of between 0 and 3.

33. The composition according to claim 30, wherein the metal M of the chelate or of the alkoxide (IV.3) is Ti, Zr, Ge, Li or Mn.

34. The composition according to claim 21, wherein the adhesion promoter comprises:
vinyltrimethoxysilane (VTMO)(IV.1),
3-glycidoxypropyltrimethoxysilane (GLYMO)(IV.2), and
butyl titanate (IV.3).

35. The composition according to claim 21, wherein the unsaturated resin (VII) comprises at least one vinyl per molecule and corresponds to the following formulae:
MM^{Vi}DD^{Vi}Q (XV),
MD^{Vi}Q (XVI)
or
MM^{Vi}Q (XVII).

36. The composition according to claim 30, comprising the constituents (I) to (VIII), as % by weight on a dry basis with respect to the total weight:
(I) 1 to 80
(II) 0.1 to 20
(III) 0.0002 to 0.04
(IV.1) 0.01 to 5
(IV.2) 0.01 to 5
(IV.3) 0.01 to 3
(V) 0 to 90
(VI) 0 to 0.5
(VII) 0 to 80, and
(VIII) 0.2 to 5.

37. The composition according to claim 36, wherein the % by weight on a dry basis with respect to the total weight are:
(I) 10 to 60
(II) 0.5 to 10
(III) 0.0005 to 0.02
(IV.1) 0.05 to 2
(IV.2) 0.05 to 2
(IV.3) 0.1 to 1
(V) 10 to 80
(VI) 0.005 to 0.3
(VII) 5 to 70, and
(VIII) 0.5 to 2.

38. A two-component precursor system of the composition as defined in claim 21, comprising:
two separate parts A and B intended to be mixed to form the composition,
said parts A and B comprising the catalyst (III) and a single polyorganosiloxane entity (I) or (II),
the part A or B comprising the compound (IV.1) of the promoter (IV) does not comprise the catalyst (III),
the resin (VII) being in the part A or the part B or in both parts A and B, the part A or B comprising the POS (II) and the resin (VII) being devoid of catalyst (III), and
the thixotropic compound (VIII) being in the part A or B comprising the catalyst (III).

39. An adhesive bonding of components for the construction of motor vehicles, and for the construction of domestic electrical appliances comprising a composition as defined in claim 21.

40. A molding crosslinkable adhesive silicone composition comprising a composition as defined in claim 21.
